(19) United States
(12) Patent Application Publication
(10) Pub. No.: US 2025/0232605 A1
(43) Pub. Date: Jul. 17, 2025

(54) IMAGE RECOGNITION METHOD AND APPARATUS

(71) Applicant: DJANGO ROBOTICS SHENZHEN CO., LTD., Shenzhen (CN)

(72) Inventors: Song LIANG, Shenzhen (CN); Yuezhong WU, Shenzhen (CN)

(21) Appl. No.: 19/066,169

(22) Filed: Feb. 28, 2025

Related U.S. Application Data
(63) Continuation of application No. PCT/CN2024/072024, filed on Jan. 12, 2024.

(51) Int. Cl. G06V 30/422; G06T 11/20; G06V 10/26

(52) U.S. Cl. CPC G06V 30/422; G06T 11/20; G06V 10/26

(57) ABSTRACT

The present application discloses an image recognition method and apparatus. The method comprises: recognizing an image to be recognized as a first type of grids and a second type of grids, wherein a pixel of the first/second type of grids is greater than a pixel threshold; dividing a region consisting of the first type of grids into a plurality of rectangles based on preset rules, and determining an adjacent edge of any two adjacent rectangles as a gateway, wherein the gateway is used to determine whether a target object can enter a second rectangle from a first rectangle via an gateway between the first rectangle and the second rectangle; generating a graphical model based on the gateway, wherein a vertex of the graphical model is the gateway; and determining a target path in the image to be recognized based on the graphical model, a starting point and an end.

### CROSS REFERENCE

This application is a continuation of International Application No. PCT/CN2024/072024, filed on Jan. 12, 2024, the entire contents of which are incorporated herein by reference.

### TECHNICAL FIELD

The present application relates to the field of computer technology, and in particular to an image recognition method and apparatus.

### BACKGROUND

Grayscale images are widely used to record maps, in which a region with a higher grayscale value is an unreachable region (black point) and a region with a lower grayscale value is a reachable region (white point). A data interface thereof can be abstracted into a two-dimensional array, and the A-star algorithm is used for path calculation.

However, when a map is relatively large and includes a large amount of pixels, and memory and processor resources of a computer are limited, a large map cannot be processed rapidly, and the map needs to be scaled down before use. The scaling technique of some implementations is lossy, which can result in loss of boundary pixels. Without scaling, calculation may be slow due to excessive pixels, or the system performance may be degraded due to occupation of excessive memory and processor resources.

### SUMMARY

An objective of the embodiments of the present application is to provide an image recognition method and apparatus.

In a first aspect, an embodiment of the present application discloses an image recognition method, the method includes: recognizing an image to be recognized as a first type of grids and a second type of grids, wherein a pixel of the first type of grids is greater than a pixel threshold, and a pixel of the second type of grids is greater than the pixel threshold; dividing a region consisting of the first type of grids into a plurality of rectangles based on a preset rule, and determining an adjacent edge of any two adjacent rectangles as a gateway, wherein the gateway is used to determine whether a target object is allowed to enter a second rectangle from a first rectangle via the gateway between the first rectangle and the second rectangle; generating a graphical model based on the gateway, wherein a vertex of the graphical model is the gateway; and determining a target path in the image to be recognized based on the graphical model, a starting point and an end.

In a second aspect, an embodiment of the present application discloses an image recognition apparatus which includes: a recognition module for recognizing an image to be identified as a first type of grids and a second type of grids, wherein a pixel of the first type of grids is greater than a pixel threshold, and a pixel of the second type of grids is greater than the pixel threshold; a division module for dividing a region consisting of the first type of grids into a plurality of rectangles based on a preset rule, and determining an adjacent edge of any two adjacent rectangles as a gateway, wherein the gateway is used to determine whether a target object is allowed to enter a second rectangle from a first rectangle via the gateway between the first rectangle and the second rectangle; a generation module for generating a graphical model based on the gateway, wherein a vertex of the graphical model is the gateway; and a determination module for determining a target path in the image to be recognized based on the graphical model, a starting point and an end.

In a third aspect, an embodiment of the present application discloses an electronic device, the electronic device includes a processor, a memory, and a program or instruction that is stored in the memory and is executable on the processor, and the program or instruction, when executed by the processor, implements the steps of the method of the first aspect.

### BRIEF DESCRIPTION OF DRAWINGS

FIG. 1 is a flow chart of an image recognition method provided by an embodiment of the present application;

FIG. 2 is a schematic diagram of a detailed flow chart of an image recognition method provided by an embodiment of the present application;

FIG. 3 is a schematic diagram of a rectangular division method provided by an embodiment of the present application;

FIG. 4 is a schematic diagram of coordinate representation of vertices of a rectangle provided by an embodiment of the present application;

FIG. 5 is a schematic diagram of a first vertex of a rectangle provided by an embodiment of the present application;

FIG. 6 is a schematic diagram of temporary marking of a generated block provided by an embodiment of the present application;

FIG. 7 is a schematic diagram of black point shielding provided by an embodiment of the present application;

FIG. 8 is a schematic diagram of point L provided by an embodiment of the present application;

FIG. 9 is a schematic diagram of a KL position without black points thereinside provided by an embodiment of the present application;

FIG. 10 is a schematic diagram of point L provided by an embodiment of the present application;

FIG. 11 is a schematic diagram of selection of a maximum L value provided by an embodiment of the present application;

FIG. 12 is a schematic diagram of white table acceleration provided by an embodiment of the present application;

FIG. 13 is a schematic diagram of backfilling provided by an embodiment of the present application;

FIG. 14 is a schematic diagram of local correction provided by an embodiment of the present application;

FIGS. 15-16 are schematic diagrams of the number of generated blocks provided by an embodiment of the present application;

FIG. 17 is a schematic diagram of block gaps provided by an embodiment of the present application;

FIGS. 18-21 are schematic diagrams of bridge blocks provided by an embodiment of the present application;

FIG. 22 is a schematic diagram of the number of generated blocks provided by an embodiment of the present application;

FIG. 23 is a detailed flow chart of block generation provided by an embodiment of the present application;

FIG. 24 is a schematic diagram of a gateway provided by an embodiment of the present application;

FIG. 25 is a schematic diagram of generation of a graphical model provided by an embodiment of the present application;

FIG. 26 is a schematic diagram of a vertex of a graphical model provided by an embodiment of the present application;

FIG. 27 is a schematic diagram of an arc of a graphical model provided by an embodiment of the present application;

FIG. 28 is a schematic diagram of global path planning provided by an embodiment of the present application;

FIGS. 29-31 are schematic diagrams of direction optimization provided by an embodiment of the present application;

FIGS. 32-33 are schematic diagrams of local path optimization provided by an embodiment of the present application;

FIG. 34 is a structural schematic diagram of an image recognition apparatus provided by an embodiment of the present application; and

FIG. 35 is a schematic diagram of an electronic device provided by embodiment of the present application.

### DETAILED DESCRIPTION

The embodiments of the present application will be described in detail below, and examples of the embodiments are shown in the accompanying drawings, where the same or similar reference numerals throughout the present application represent the same or similar elements or elements with the same or similar functions. The embodiments described below with reference to the accompanying drawings are exemplary and are only used to explain the present application, and should not be construed as limitations on the present application. All other embodiments obtained by those skilled in the art without creative labor on the basis of embodiments in the application are within the scope of protection of the application.

The features with terms “first” or “second” in the specification and claims of the present application can explicitly or implicitly comprise one or more of these features. In description of the present application, unless otherwise specified, “a plurality of” means two or more. In addition, “and/or” in the specification and claims indicates at least one of the objects connected therewith, and the character “/” generally indicates that the objects associated therewith are in an “or” relationship.

In description of the present application, it should be understood that the orientation or positional relationship indicated by the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential” and the like is based on the orientation or positional relationship shown in the accompanying drawings, which is only for the convenience of describing the present application and simplifying the description, rather than indicating or implying that the indicated device or element must have a specific orientation, be constructed and operated in a specific orientation, therefore, it should not be understood as a limitation on the present application.

In description of this application, it should be noted that, unless otherwise clearly specified and defined, the terms “install”, “interconnect”, and “connect” should be understood in a broad sense, for example, it can be fixedly connected, detachably connected, or integrally connected; it can be mechanically connected or electrically connected; it can be directly connected, or it can be indirectly connected through intermediate medium, or two elements can be in internal communication with each other. For those skilled in the art, the specific meanings of the above terms in the present application can be understood according to specific circumstances.

The image recognition method and apparatus provided by embodiments of the application will be described in detail by specific embodiments and application scenarios thereof with reference to the accompanying drawings.

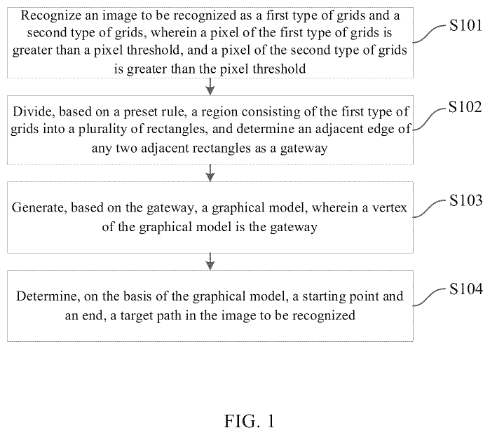

FIG. 1 is a schematic flow chart of an image recognition method provided by an embodiment of the present application. As shown in FIG. 1, the image recognition method may include steps S101 to S104.

In S101, an image to be recognized is recognized as a first type of grids and a second type of grids, wherein the pixel of the first type of grids is greater than a pixel threshold, and the pixel of the second type of grids is greater than the pixel threshold.

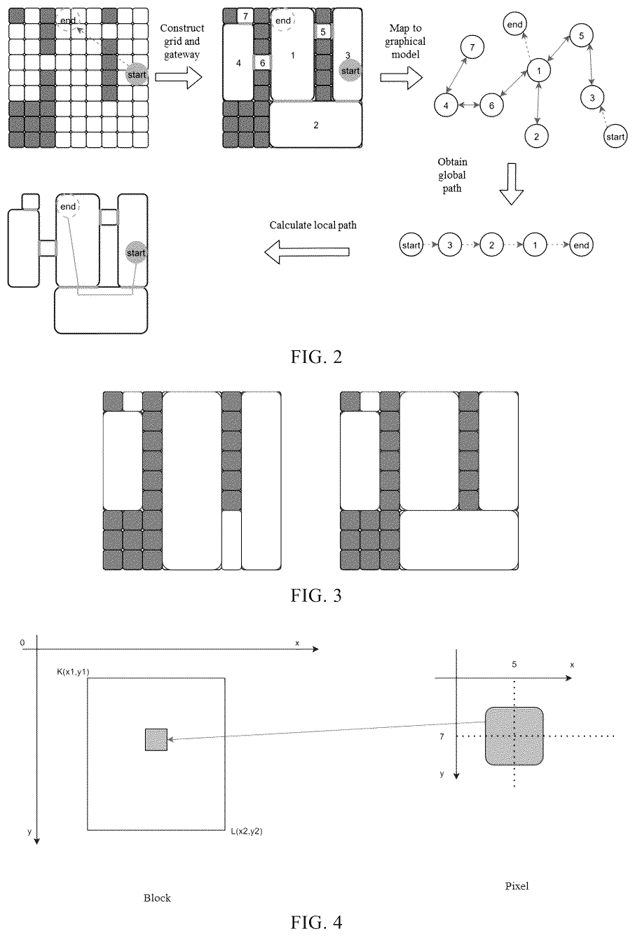

As shown in FIG. 2, the first type of grid may be a white grid, and the second type of grid can be a black grid. The white grid represents a passable region, and the black grid represents an impassable region.

In S102, a region consisting of the first type of grids is divided into a plurality of rectangles based on a preset rule, and an adjacent edge of any two adjacent rectangles is determined as a gateway.

The gateway is used to determine whether a target object is allowed to enter a second rectangle from a first rectangle via the gateway between the first rectangle and the second rectangle. A target object can be a navigation object, such as a vehicle, a pedestrian, a robot, etc., which is not limited in embodiments of the present application.

In S103, a graphical model is generated based on the gateway, where a vertex of the graphical model is the gateway.

In S104, a target path in the image to be recognized is determined based on the graphical model, a starting point and an end.

That is to say, the target path, i.e., a channel, can be determined from the image to be recognized by the above steps, so that a target object can pass through based on the channel.

In an embodiment of the present application, firstly, the image to be recognized is recognized as the first type of grids and the second type of grids, where the pixel of the first type of grids is greater than a pixel threshold, and the pixel of the second type of grids is greater than the pixel threshold; secondly, the region consisting of the first type of grids is divided into a plurality of rectangles based on the preset rule, and the adjacent edge of any two adjacent rectangles is determined as the gateway, wherein the gateway is used to determine whether a target object is allowed to enter the second rectangle from the first rectangle via the gateway between the first rectangle and the second rectangle; then the graphical model is generated based on the gateway, wherein the vertex of the graphical model is the gateway; and the target path in the image to be recognized is determined based on the graphical model, the starting point and the end. The embodiments of the present application can be applied to various types of images, and the generated grids are vector data whose data volume is smaller than that of a point matrix graph, convenient transmission and storage are realized, and compared with an adjacency matrix of a scaled image, the speed is almost the same, but the accuracy is higher.

As shown in FIG. 2, firstly, an image to be recognized is recognized as black and white grids, wherein the white grids represent passable regions, the white regions are constructed into a plurality of large rectangles and gateways, and then mapped to a graphical model, finally, a target path is output.

In some cases, the white regions of a map can be segmented into rectangular blocks of different sizes, and the blocks are connected by gateways formed by adjacent faces, so as to form a block network of an irregular shape. A navigation object can move freely within each block (walking in a straight line). To reach another block, the navigation object needs to pass through the gateway.

The gateway may be used for width check, if the width of a target object exceeds the width of the gateway, the target object cannot pass; the gateway may also be used for direction check, if the direction from the starting point of a target object to the gateway is reverse to the direction of the block, the target object cannot pass.

In one possible implementation of the present application, dividing the region consisting of the first type of grids into a plurality of rectangles based on the preset rule may include: the vertices of the rectangles are determined based on preset rule, where the preset rule include at least one of reducing the number of rectangles, increasing the area of rectangles, or reducing the aspect ratio of rectangles; and the plurality of rectangles are determined based on the vertices.

That is to say, a generated large rectangle, i.e., block, can be determined by determining vertices. For example, it can be determined by the coordinates of two opposite vertices of the rectangle so as to reduce the calculation amount.

The more blocks there are, the more vertices of a graphical model there are, which results in slow path planning. Therefore, it is necessary to minimize the number of blocks as possible, when the total white area is constant, it is necessary to make the generated blocks larger. For example, for the same map, different division methods lead to greatly different results. As shown in FIG. 3, at least the following two division methods are comprised: the maximum area in the left side is larger, whereas regions in the right are closer to square. Here, an attempt is made for the purpose of maximizing the area of the blocks.

In one possible implementation of the present application, determining the vertices of rectangles based on the preset rule may include: the coordinates of the first vertices of the plurality of rectangles are obtained; based on the preset rule and any one of the first vertices, a first rectangle with the largest area corresponding to the first vertex, s and the second vertex opposite to the first vertex of the first rectangle are determined, until the region consisting of the first type of grids is divided into a plurality of rectangles of which the area is larger than an area threshold.

In order to find these blocks, how to represent one block can be determined firstly. In the coordinate system in the figure, X is positive in the right and Y is positive in the lower, therefore two coordinates can be used for marking, i.e., the upper left corner and the lower right corner, which are named K and L, respectively. Their positions in the coordinate system in the figure and the pixel positions of blocks are shown in FIG. 4. A plurality of rectangles can be quickly determined by determining the vertices.

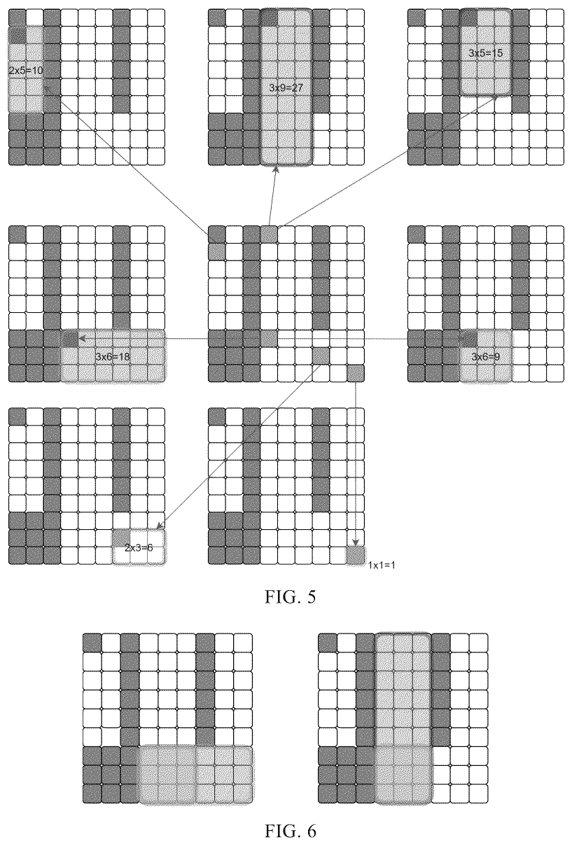

As shown in FIG. 5, the point K is determined firstly. Determination of point K is relatively easy, as long as it is a white pixel. Each K has at least one L that can form a block with it (the smallest is K itself). It can be seen that one point K may have many corresponding L with different areas, and the L with the largest area needs to be filtered out. At the same time, it should be noted that blocks of one point K overlaps with blocks of other K points, which means that blocks in other positions will be affected after one block is generated. Therefore, after one block is generated, its corresponding region need to be painted black, as shown in FIG. 6.

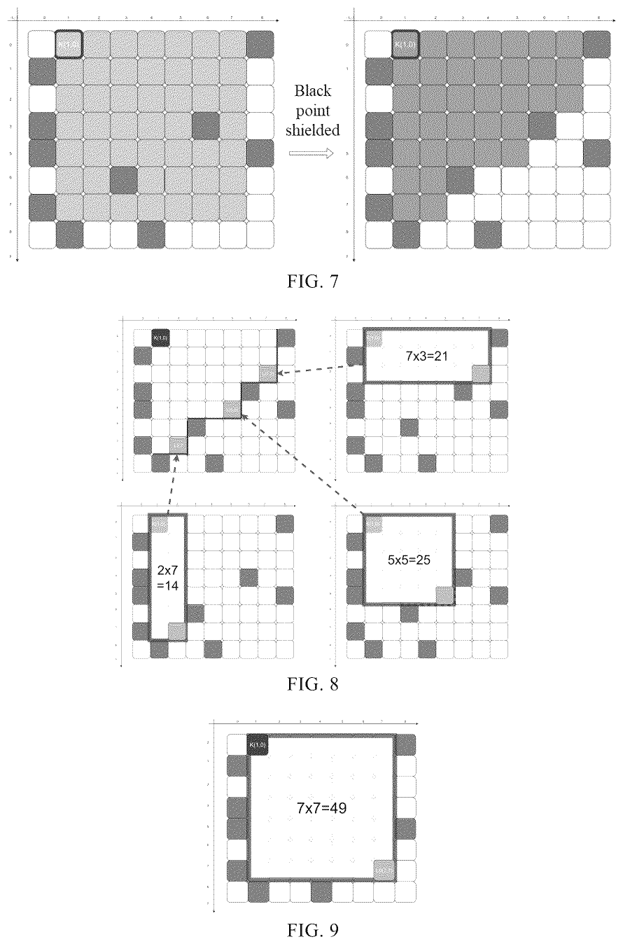

Since there should be no black points inside blocks, when K is determined, Lis within a rectangular range with a width of w and a height of h, however, many white points are filtered out, and the remaining optional L are shown in FIG. 7.

However, among these points, the points that can potentially form the largest area are all characterized by being located at a corner. When calculating the maximum area Sm of the point, it is only necessary to select the largest area among the areas of these finite points L, as shown in FIG. 8.

It should be noted that if there are no black points inside, the last L is at the farthest point, as shown in FIG. 9.

Since L is at an inflection point, in order to determine the specific coordinates of this point, 3 variables are defined: a minimum width (kw), a previous minimum width (pw), a minimum width of a current row (hw), and the minimum value min that has been operated, take the minimum value of pw and hw, and the pw and hw of the first row are equal. The calculation formula is as follows:

kw=min(pw,hw)

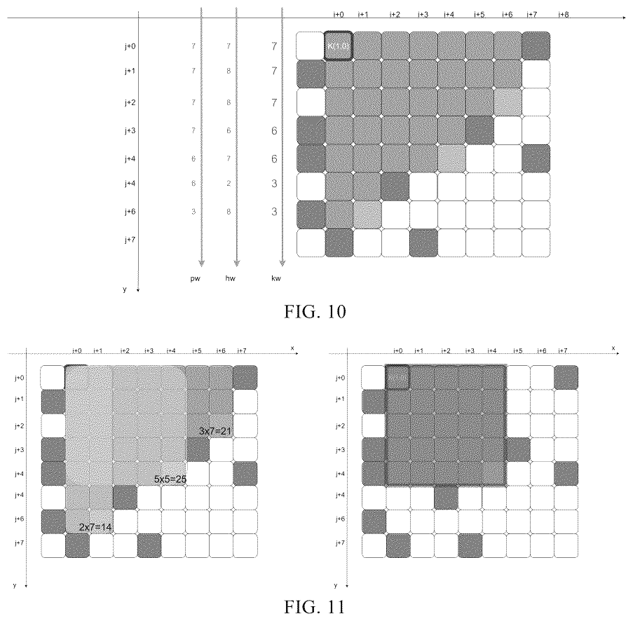

As shown in FIG. 10, whenever pw and kw are not equal, a new Lis generated, which together with the L in the last row form all L, the largest area of which is a 5×5 rectangle, therefore, the largest area of rectangles at this point is 25, as shown in FIG. 11.

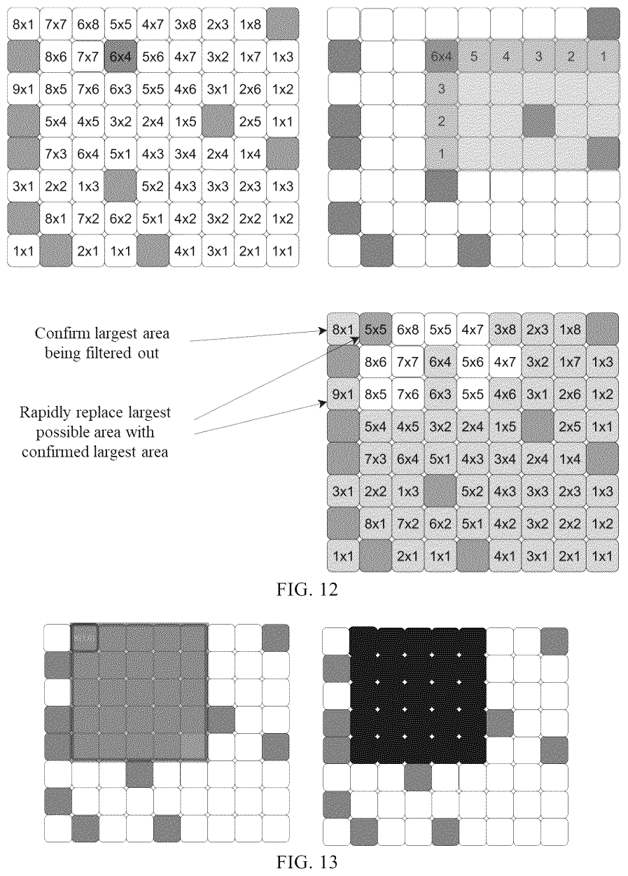

During initial calculation of the area, it is necessary to know the maximum possible area of a point, and if the maximum possible area is lower than the maximum area that has been generated, all L of the point are skipped. Since it is necessary to know the initial w and h rapidly, a table can be constructed to record the distance to the black point in the X and Y directions, the X×Y area of this point is called the maximum possible area Smay. If Smay is smaller than the maximum area Smax, then solution of L of this point is skipped, as shown in FIG. 12.

Since blocks generated at different positions may overlap, the region affected by the largest block in the current map may be painted black to eliminate the problem of repeated generation of the block, as shown in FIG. 13. This prevents black points from being counted in other white blocks. In one possible implementation of the present application, after determining, based on the preset rule and any one of the first vertices, the first rectangle with the largest area corresponding to the first vertex and the second vertex opposite to the first vertex in the first rectangle, the method may further include: the region where the determined first rectangle is located is marked, where marking is used to distinguish the first rectangle from the first type of grids; and the region consisting of the first type of grids is updated, where the updated region does not include the marked region.

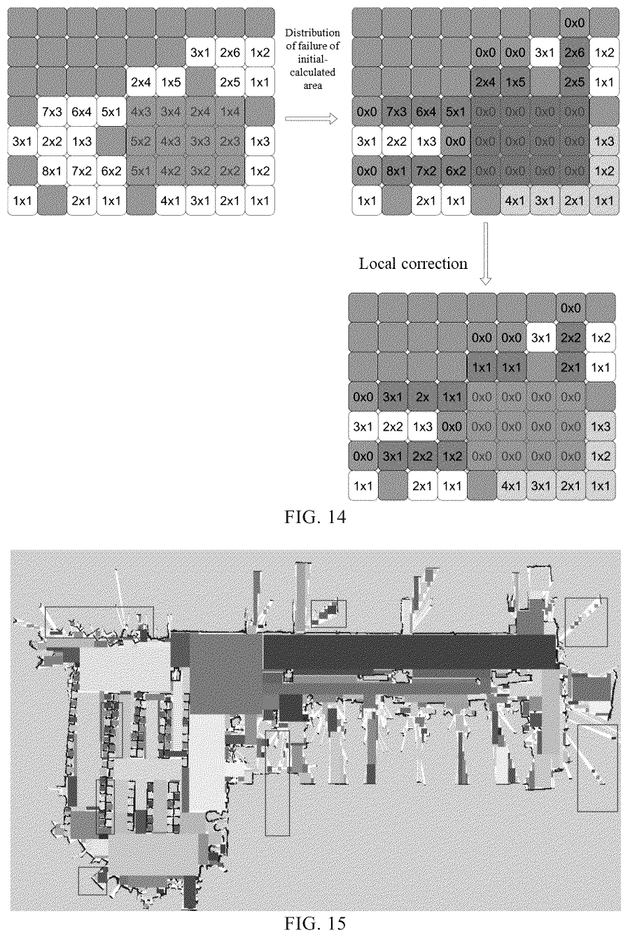

After backfilling, the white table needs to be updated. However, since regenerating a new white table is costly, the white table can be partially updated, as shown in FIG. 14.

The purpose of replacing pixels with blocks is to reduce the computation amount of image recognition, such as the computation amount of a navigation model. In some complex edges, due to the complexity of pixels, there are alternating black and white pixels, if there is no restriction, one white point will generate one block, resulting in too many blocks. Moreover, a target object, such as a robot, a person, and a vehicle, cannot actually reach these places, as shown in the boxed regions in FIG. 15. When the minimum area is 0.01 m², the number of generated blocks is at least 1216, which leads to large the computation amount.

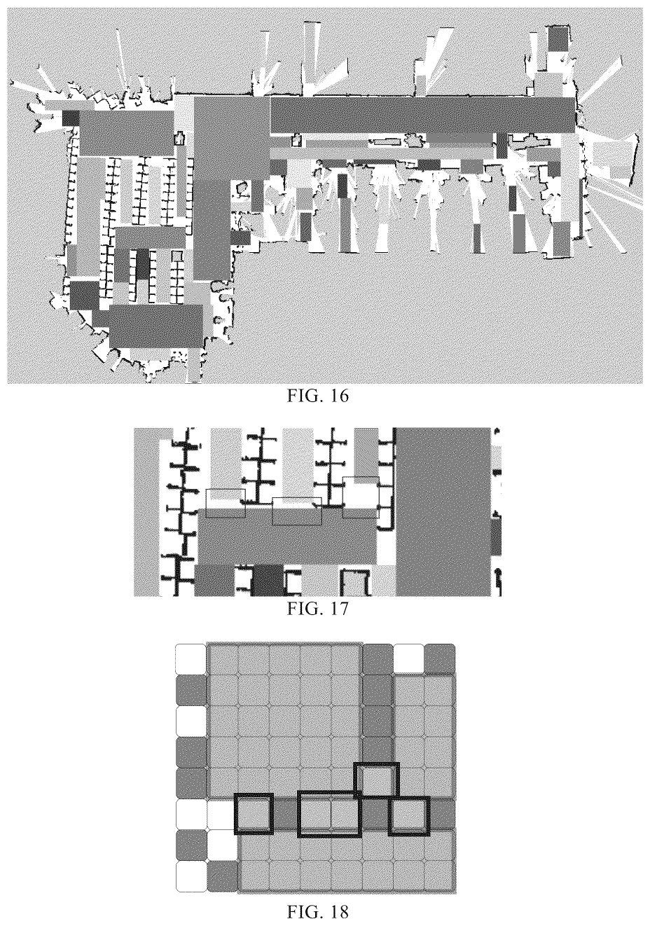

The number of blocks can be reduced by increasing the minimum area, as shown in FIG. 16, when the minimum area is 1 m², the number of generated blocks is 64. That is to say, after the minimum area is increased, larger blocks are generated, and the number of generated blocks is smaller. However, this brings another problem, there are gaps between many large blocks, such as the boxed regions in FIG. 17, which will result in failure in navigation.

In order to solve the problem of gaps, in one possible implementation of the present application, after dividing the region consisting of the first type of grids into a plurality of rectangles based on the preset rule, the method may further include: a plurality of bridge regions are determined based on the region of which the area is smaller than an area threshold, where the bridge region is used to connect two adjacent rectangles without an adjacent edge; and upon the condition that there are at least two bridge regions between two adjacent rectangles without an adjacent edge, the bridge region with the largest width is determined as a target bridge region of the two adjacent rectangles without adjacent edge.

That is to say, a plurality of bridge regions, i.e. bridge blocks, can be provided, the area of a bridge block is smaller than the minimum area, and a bridge block is specially used to connect two large blocks. the generation sequence of the bridge regions is based on the two large blocks to be connected. With the bridge block as the center, there can be large blocks in 4 directions of up, down, left, and right, and any two of them can be connected, as shown in FIG. 18, the position marked by a black box is the bridge region.

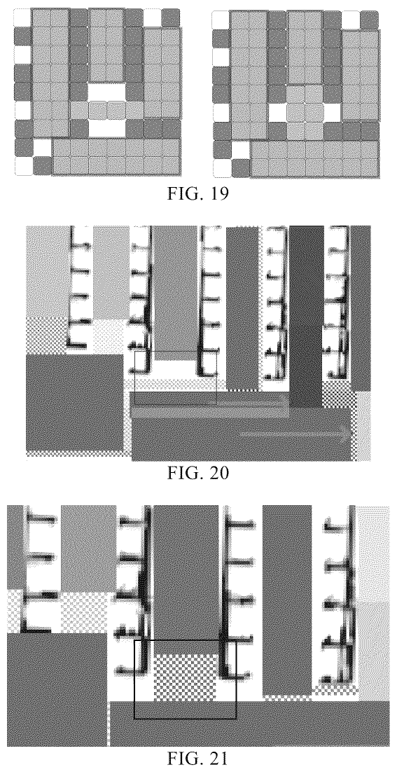

At the same time, it is necessary to perform contact surface check, a contact surface refers to the width of a bridge. The wider the contact surface is, the better. Since a bridge block cannot be connected to another bridge block, without check, a narrow bridge can possibly interrupt a wide bridge. Besides, a bridge that is too narrow for a robot and person to pass is useless once generated. As shown in FIGS. 19-21, a bridge block is selected based on a large contact surface with blocks, the selected bridge blocks are shown in the picture on the right of FIG. 19 and shown in FIG. 21.

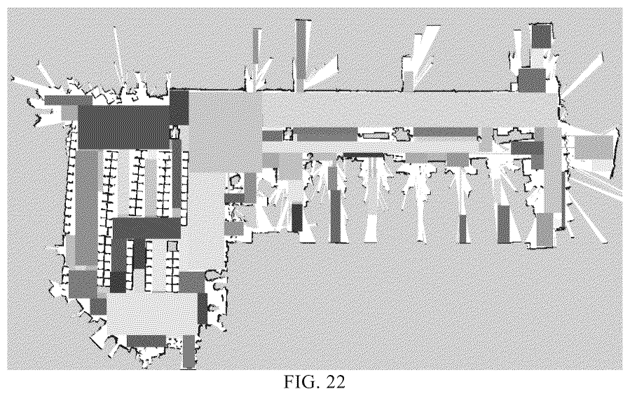

When the minimum area is set to 1 m², the generated bridge blocks are shown in FIG. 22. When the minimum area is 1 m², the number of blocks generated (large blocks+bridge blocks) is 123 in total, which greatly reduces the number of blocks and the calculation amount.

In a subsequent navigation model, it is necessary to estimate the cost of navigating across blocks. If the blocks are sorted by area only, the generated blocks can have a very high aspect ratio, resulting in errors in calculation of approximate path length in subsequent navigations. Therefore, it is more desirable to limit the aspect ratio of blocks.

An aspect ratio that is too low is called badWidth, which is calculated by taking the square root of half of the minimum generated area (minAreaSize), the formula is as follows:

badWidth=Math·sqrt(minAreaSize/2);

At the same time, a score is determined, which is equal to 30% of the current area, and different penalties and rewards are given to different blocks:
for those with a low aspect ratio: score=minimum area+score*aspect ratio;
for those with a high aspect ratio: score=current area*(1+aspect ratio);
finally, since both a robot and person have a minimum passing width limit, the minimum width of possible navigable objects is also limited.

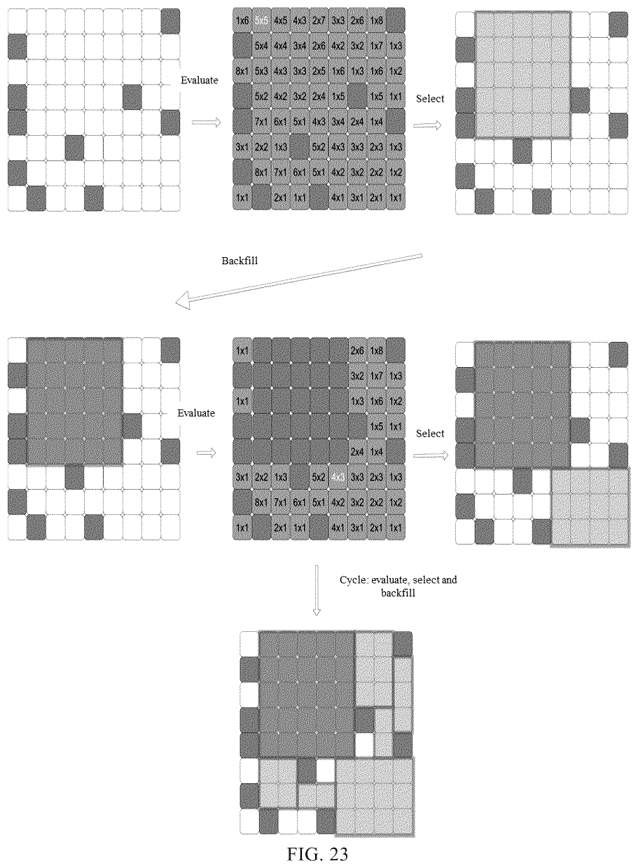

Taking the minimum block area of 2 as an example, the generation process is shown in FIG. 23.

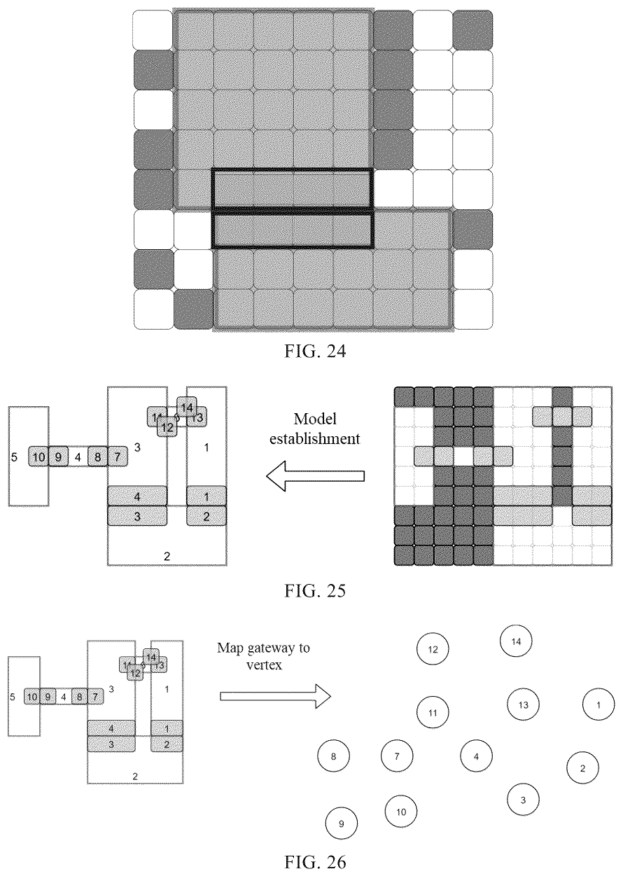

At present, the blocks have been generated, in order to build a graphical model, it is necessary to determine the arcs, that is, the connections between blocks. The simplest way is to take the adjacent edges of blocks as the arcs of graph theory. The adjacent edges of two blocks are drawn as a gate open to each other, as indicated by the black box in FIG. 24.

In one possible implementation of the present application, generating the graphical model based on the gateway may include: a gateway is extracted from inside of each rectangle, so as to obtain a vertex of the graphical model, wherein the gateway is a region consisting of first type grids that are adjacent to an adjacent edge of any two adjacent rectangles; two adjacent gateways are connected, and the connecting line is determined as an arc of the graphical model, wherein the arc of the graphical model is directed; and the graphical model is generated based on the vertex and arc of the graphical model.

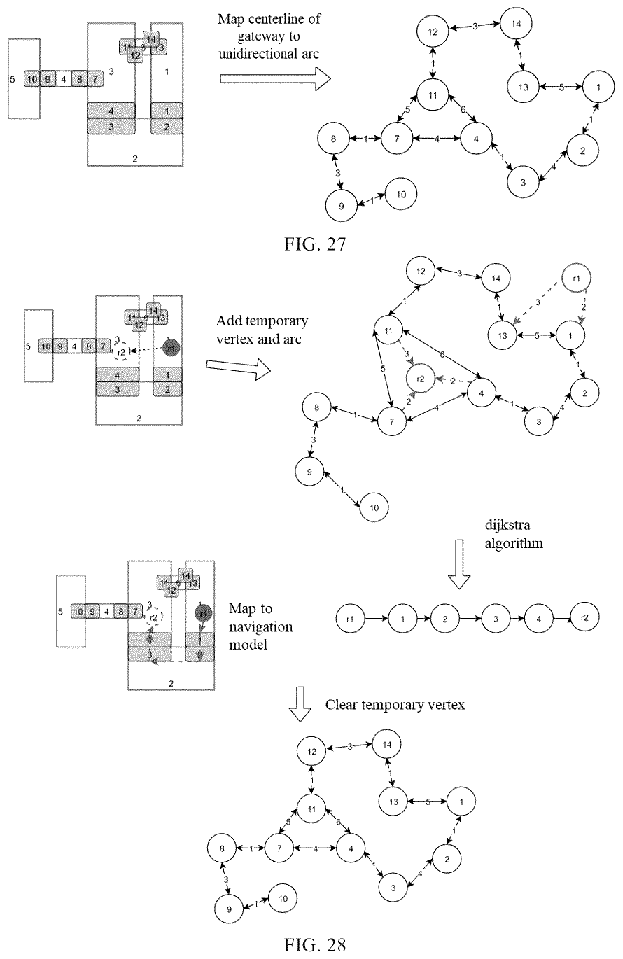

In a previous graphical model, a moving cost among vertices is needed, but if the vertex is of a block, it is impossible to determine the cost of moving from block 3 to block 2, and only movement from block 3 to block 2 can be known. Therefore, a gateway is used as a vertex instead, and the connection between gateways is an arc of a graph theory with a direction. The estimated cost is the straight-line distance from the midpoint of a gateway to the midpoint of another gateway, as shown in FIG. 25. The vertices of the graphical model are shown in FIG. 26, and the arcs of the graphical model are shown in FIG. 27. The global planning path is shown in FIG. 28.

In one possible implementation of the present application, the image recognition method may further include: when the cosine of the included angle between the arc of the graphical model and the direction of the rectangle is positive, the target object is allowed to pass.

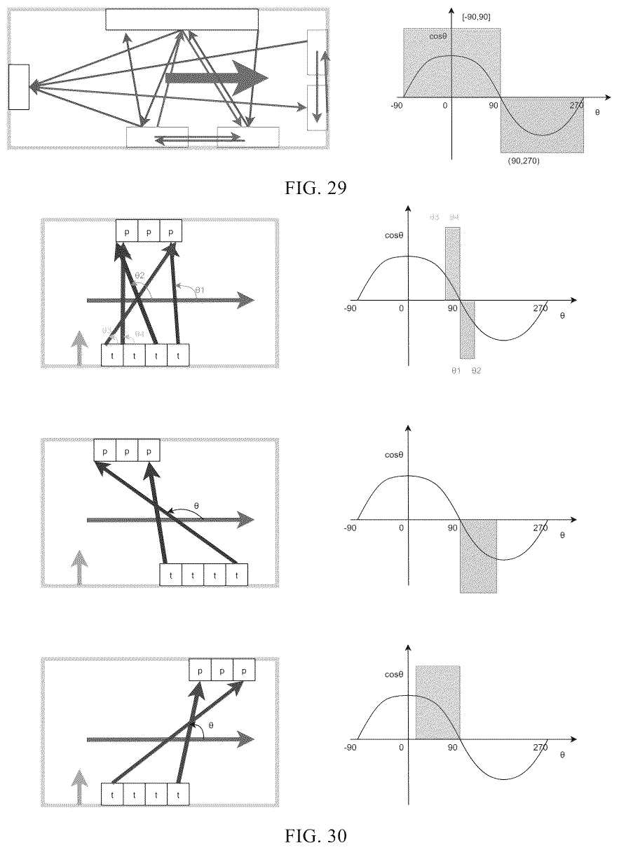

As shown in FIG. 29, where the direction of the region is rightwards, the gateway is directly connected to the midpoint, thereby forming a centerline. Distribution of the included angle between the centerline and the direction of the region is shown in FIG. 29, form which those with positive cosine are safe for pass.

The passability is dynamic only when the left direction of the gateway is orthogonal to the direction of the region, as shown in FIG. 30, only when the width of the overlapping part of two gateways is greater than the width of a navigation object, it is possible to reach the other side and only movement within the limited range is allowed.

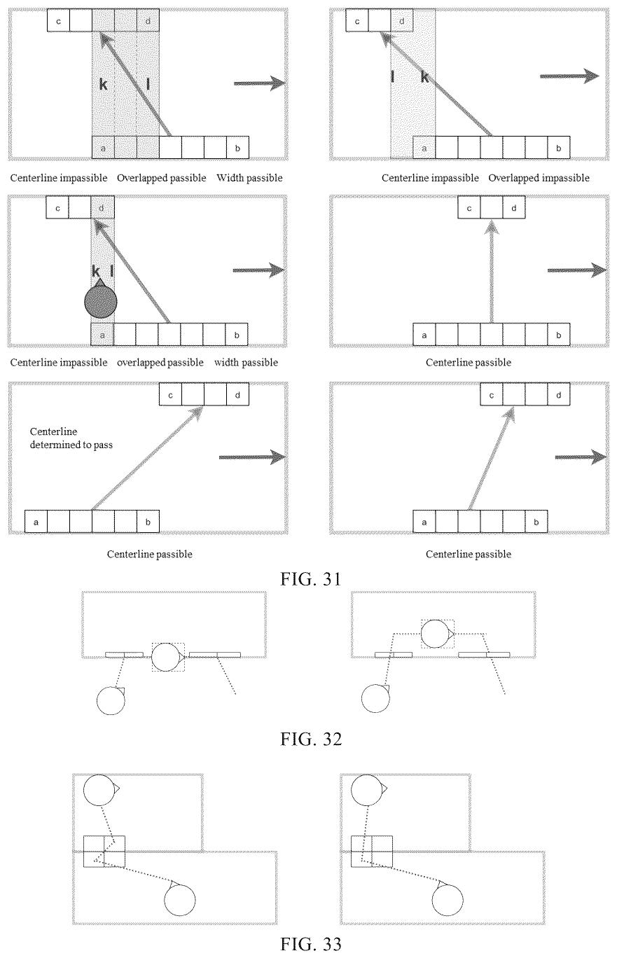

As shown in FIG. 31, K is the maximum value of ac, and L is the minimum value of bd, and the opposite is true from top to bottom. Only the overlapping areas are processed since filtering in the direction of centerline has filtered out the non-overlapping range.

In one possible implementation manner of the present application, the image recognition method may further include: upon the condition that at least two gateways are within the same rectangle and the target path passes through the at least two gateways, the target path is modified to pass through the inside of the same rectangle.

That is to say, local path optimization may be performed. When both gateways are on one edge within the same block, waypoints can be pushed inward by half the width of a navigation object, as shown in FIG. 32.

Other optimizations may include taking only one point of a gateway, since a difference of 1 pixel between points of gateways can cause a target object, such as a vehicle or a robot, to perform invalid directional deflection, as shown in FIG. 33, only one gateway needs to be selected.

It should be noted that the image to be recognized in the embodiments of the present application can be a grayscale image or an image in other formats, such as PNG, JPE, etc., as long as the image can output pixels in the end.

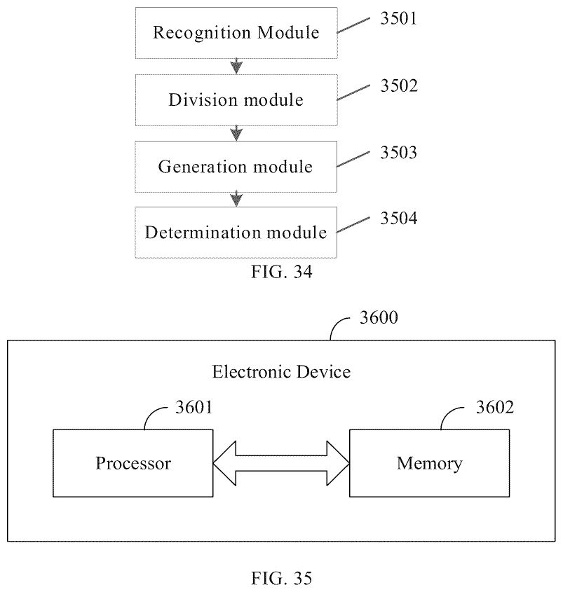

FIG. 34 is a schematic diagram of an image recognition apparatus provided by an embodiment of the present application, as shown in FIG. 34, the image recognition apparatus may include a recognition module 3501, a division module 3502, a generation module 3503, and a determination module 3504.

The recognition module 3501 is used to recognize an image to be recognized as a first type of grids and a second type of grids, wherein the pixel of the first type of grids is greater than a pixel threshold, and the pixel of the second type of grids is greater than the pixel threshold; the division module 3502 is used to divide a region consisting of the first type of grids into a plurality of rectangles based on a preset rules, and determine an adjacent edge of any two adjacent rectangles as a gateway, wherein the gateway is used to determine whether a target object is allowed to enter a second rectangle from a first rectangle via the gateway between the first rectangle and the second rectangle; the generation module 3503 is used to generate a graphical model based on the gateway, wherein an vertex of the graphical model is the gateway; and the determination module 3504 is used to determine a target path in the image to be recognized based on the graphical model, a starting point and an end.

In an embodiment of the present application, firstly, the recognition module 3501 recognizes the image to be recognized as the first type of grids and the second type of grids, wherein the pixel of the first type of grid is greater than the pixel threshold, and the pixel of the second type of grid is greater than the pixel threshold; then the division module 3502 divides the region consisting of the first type of grids into the plurality of rectangles based on the preset rule, and determines the adjacent edge of any two adjacent rectangles as the gateway, wherein the gateway is used to determine whether a target object is allowed to enter the second rectangle from the first rectangle via the gateway between the first rectangle and the second rectangle; the generation module 3503 generates het graphical model based on the gateway, wherein the vertex of the graphical model is the gateway; finally, the determination module 3504 determines the target path in the image to be recognized based on the graphical model, the starting point and the end. The embodiments of the present application can be applied to various types of images, and the generated grids are vector data whose data volume is smaller than that of a point matrix graph, convenient transmission and storage are realized, and compared with an adjacency matrix of a scaled image, the speed is almost the same, but the accuracy is higher.

In one possible implementation of the present application, the division module 3502 is used to: determine the vertices of the rectangles based on the preset rule, wherein the preset rules include at least one of reducing the number of rectangles, increasing the area of rectangles, or reducing the aspect ratio of rectangles; and determine the plurality of rectangles based on the vertices.

In one possible implementation of the present application, the division module 3502 is used to: obtain the coordinates of the first vertices of the plurality of rectangles; determine, based on the preset rule and any one of the first vertices, a first rectangle with the largest area corresponding to the first vertex and a second vertex opposite to the first vertex in the first rectangle, until the region consisting of the first type of grids is divided into a plurality of rectangles of which the area is larger than an area threshold.

In one possible implementation of the present application, the image recognition apparatus may further include: a marking module and an updating module.

The marking module is used to mark the region where the determined first rectangle is located, marking is used to distinguish the first rectangle from the first type of grids; and the updating module is used to update the region consisting of the first type of grids, and the updated region does not include the marked region.

In one possible implementation of the present application, the image recognition apparatus may further include a second determination module and a third determination module.

The second determination module is used to determine, based on a region of which the area is smaller than an area threshold, a plurality of bridge regions, wherein the bridge region is used to connect two adjacent rectangles without an adjacent edge; and the third determination module is used to determine, upon the condition that there are at least two bridge regions between two adjacent rectangles without an adjacent edge, a bridge region with the largest width as a target bridge region of the two adjacent rectangles without an adjacent edge.

In one possible implementation of the present application, the generation module 3503 is used to: extract a gateway from inside of each rectangle, so as to obtain a vertex of the graphical model, wherein the gateway is a region consisting of the first type of grids and adjacent to an adjacent edge of any two adjacent rectangles; connect two adjacent gateways and determine a connecting line as an arc of the graphical model, where the arc of the graphical model is directed; and generate the graphical model based on the vertex and arc of the graphical model.

In one possible implementation of the present application, the image recognition apparatus may further include a fourth determination module.

The fourth determination module is used to determine the target object is allowed to pass upon the condition that the cosine of an included angle between the arc of the graphical model and the direction of the rectangle is positive.

In one possible implementation of the present application, the image recognition apparatus may further include a correction module.

The correction module is used to modify the target path to pass through the inside of the same rectangle upon the condition that at least two gateways are within the same rectangle and the target path passes through the at least two gateways.

The image recognition apparatus provided by the embodiments of the present application can implement the various processes implemented by the method embodiments of FIGS. 1-33, and can achieve the same technical effect, which will not be repeated herein to avoid repetition.

As shown in FIG. 35, an embodiment of the present application further provides an electronic device 3600, comprising a processor 3601, a memory 3602, and a program or instruction stored in the memory 3602 and is executable on the processor 3601, and the program or instruction, when executed by the processor 3601, implements the various processes implemented by embodiments of the image recognition method, and can achieve the same technical effect, which will not be repeated herein to avoid repetition.

An embodiment of the present application further provides a storage medium storing a program or instruction thereon, and the program or instruction, when executed by the processor, implements the various processes implemented by the image recognition method provided by any of the above embodiments, and can achieve the same technical effect, which will not be repeated herein to avoid repetition.

The processor is the processor in the electronic device described in the above embodiment. The storage medium includes computer storage medium, such as read-only memory (ROM), random access memory (RAM), magnetic disk or optical disk.

An embodiment of the present application further provides a chip, comprising a processor and a communication interface, wherein the communication interface is coupled to the processor, and the processor is used to run programs or instructions, so as to implement the various processes of the above embodiments of the image recognition method, and can achieve the same technical effect, which will not be repeated herein to avoid repetition.

It should be understood that the chip mentioned in the embodiments of the present application may also be called a system-level chip, a system chip, a chip system or a system-on-chip, etc.

An embodiment of the present application further provides a computer program/program product, the computer program/program product is stored in a storage medium and is executable by at least one processor so as to implement the various processes of the above embodiments of the image recognition method, and can achieve the same technical effect, which will not be repeated herein to avoid repetition.

An embodiment of the present application further provides a processing device, the processing device is configured to implement the various processes of the above image recognition method embodiments, and can achieve the same technical effect, which will not be repeated herein to avoid repetition.

It should be noted that, as used herein, the terms “include”, “comprise” or any other variations thereof are intended to cover a non-exclusive inclusion, such that a process, method, article, or apparatus that comprises a series of elements not only comprises those elements, but also comprises other elements that are not explicitly listed, or further comprises elements that are inherent to the process, method, article, or apparatus. Without further limitations, an element limited by “comprising a . . . ” does not exclude the presence of other identical elements in the process, method, article, or device that comprises the element. In addition, it should be noted that the scope of the method and device in embodiments of this application is not limited to perform functions in the order shown or discussed, but may also include performing functions in a substantially simultaneous manner or in a reverse order according to the functions involved, for example, the described methods may be performed in an order different from the described, and various steps may be added, omitted, or combined. Additionally, features described with reference to certain examples can be combined into other examples.

With the description of the above implementations, those skilled in the art can clearly understand that the above implementation methods can be achieved via software and necessary general hardware platforms, as well as hardware, in many cases, the former is the preferred implementation. Based on such understanding, the technical solution of the this application essentially or the part contributing to the prior art may be embodied in the form of a computer software product, the computer software product is stored in a storage medium (such as a ROM/RAM, a magnetic disk, and an optical disk), and comprises a number of instructions enabling a terminal (which may be a mobile phone, a computer, a server, or a network device) to execute the methods described in various embodiments of this application.

The embodiments of the application are described above in conjunction with the accompanying drawings, but the application is not limited to the above-mentioned particular embodiments that are merely illustrative rather than limiting, a wide variety of forms can be made by a person skilled in the art under teachings of the application without departing from the spirit and scope of the application, all of which fall within the scope of the claims.

What is claimed is:

1. An image recognition method, comprising:
recognizing an image to be recognized as a first type of grids and a second type of grids, wherein a pixel of the first type of grids is greater than a pixel threshold, and a pixel of the second type of grids is greater than the pixel threshold;
dividing, based on a preset rule, a region consisting of the first type of grids into a plurality of rectangles, and determining an adjacent edge of any two adjacent rectangles as a gateway, wherein the gateway is used to determine whether a target object is allowed to enter a second rectangle from a first rectangle via the gateway between the first rectangle and the second rectangle;
generating, based on the gateway, a graphical model, wherein a vertex of the graphical model is the gateway; and
determining, on the basis of the graphical model, a starting point and an end, a target path in the image to be recognized.

2. The method according to claim 1, wherein dividing, based on the preset rule, the region consisting of the first type of grids into the plurality of rectangles comprises:
determining vertices of rectangles based on the preset rule, the preset rule comprises at least one of reducing a number of the rectangles, increasing an area of the rectangles, or reducing an aspect ratio of the rectangles; and
determining the plurality of rectangles based on the vertices.

3. The method according to claim 2, wherein
determining the vertices of the rectangles based on the preset rule comprises:
obtaining coordinates of first vertices of a plurality of rectangles; and
determining, based on the preset rule and any one of the first vertices, a first rectangle with the largest area corresponding to the first vertex and a second vertex opposite to the first vertex in the first rectangle, until the region consisting of the first type of grids is divided into a plurality of rectangles of which the area is larger than an area threshold.

4. The method according to claim 3, wherein after determining, based on the preset rule and any one of the first vertices, the first rectangle with the largest area corresponding to the first vertex and the second vertex opposite to the first vertex in the first rectangle, the method further comprises:
marking the region where the determined first rectangle is located, wherein marking is used to distinguish the first rectangle from the first type of grids; and
updating the region consisting of the first type of grids, wherein the updated region does not comprise a marked region.

5. The method according to claim 1, wherein after dividing, based on the preset rule, the region consisting of the first type of grids into the plurality of rectangles, the method further comprises:
determining, based on a region of which the area is smaller than an area threshold, a plurality of bridge regions, wherein the bridge region is used to connect two adjacent rectangles without an adjacent edge; and
determining, upon the condition that there are at least two bridge regions between two adjacent rectangles without an adjacent edge, a bridge region with the largest width as a target bridge region of the two adjacent rectangles without an adjacent edge.

6. The method according to claim 1, wherein generating, based on the gateway, the graphical model comprises:
extracting a gateway from inside of each rectangle, so as to obtain a vertex of the graphical model, wherein the gateway is a region consisting of the first type of grids and adjacent to an adjacent edge of any two adjacent rectangles;
connecting two adjacent gateways and determining a connecting line as an arc of the graphical model, wherein the arc of the graphical model is directed; and
generating the graphical model based on the vertex and arc of the graphical model.

7. The method according to claim 1, wherein the method further comprises:
upon the condition that the cosine of an included angle between the arc of the graphical model and the direction of the rectangle is positive, the target object is allowed to pass.

8. The method according to claim 1, wherein the method further comprises:
upon the condition that at least two gateways are within the same rectangle and the target path passes through the at least two gateways, modifying the target path to pass through the inside of the same rectangle.

9. An image recognition apparatus, comprising:
a recognition module, used for recognizing an image to be recognized as a first type of grids and a second type of grids, wherein a pixel of the first type of grids is greater than a pixel threshold, and a pixel of the second type of grids is greater than the pixel threshold;
a division module, used for dividing, based on a preset rule, a region consisting of the first type of grids into a plurality of rectangles, and determining an adjacent edge of any two adjacent rectangles as a gateway, wherein the gateway is used to determine whether a target object is allowed to enter a second rectangle from a first rectangle via the gateway between the first rectangle and the second rectangle;
a generation module, used for generating, based on the gateway, a graphical model, wherein a vertex of the graphical model is the gateway; and
a determination module, used for determining, on the basis of the graphical model, a starting point and an end, a target path in the image to be recognized.

10. An electronic device, comprising a processor, a memory, and a program or instruction that is stored in the memory and is executable on the processor, wherein the program or instruction, when executed by the processor, implements the steps of the method according to claim 1.

11. An electronic device, comprising a processor, a memory, and a program or instruction that is stored in the memory and is executable on the processor, wherein the program or instruction, when executed by the processor, implements the steps of the method according to claim 2.

12. An electronic device, comprising a processor, a memory, and a program or instruction that is stored in the memory and is executable on the processor, wherein the program or instruction, when executed by the processor, implements the steps of the method according to claim 3.

13. An electronic device, comprising a processor, a memory, and a program or instruction that is stored in the memory and is executable on the processor, wherein the program or instruction, when executed by the processor, implements the steps of the method according to claim 4.

14. An electronic device, comprising a processor, a memory, and a program or instruction that is stored in the memory and is executable on the processor, wherein the program or instruction, when executed by the processor, implements the steps of the method according to claim 5.

15. An electronic device, comprising a processor, a memory, and a program or instruction that is stored in the memory and is executable on the processor, wherein the program or instruction, when executed by the processor, implements the steps of the method according to claim 6.

16. An electronic device, comprising a processor, a memory, and a program or instruction that is stored in the memory and is executable on the processor, wherein the program or instruction, when executed by the processor, implements the steps of the method according to claim 7.

17. An electronic device, comprising a processor, a memory, and a program or instruction that is stored in the memory and is executable on the processor, wherein the program or instruction, when executed by the processor, implements the steps of the method according to claim 8.
